(19) United States
(12) Patent Application Publication
(10) Pub. No.: US 2011/0119704 A1
(43) Pub. Date: May 19, 2011

(54) METHOD AND SYSTEM FOR PRESENTING DATA TO USER TERMINALS

(75) Inventor: Janne Aaltonen, Turku (FI)

(73) Assignee: CVON INNOVATIONS LIMITED, LONDON (GB)

(21) Appl. No.: 13/001,191

(22) PCT Filed: Jun. 22, 2009
(86) PCT No.: PCT/EP09/57748

§ 371 Date: Jan. 20, 2011

Related U.S. Application Data
(60) Provisional application No. 61/132,841, filed on Jun. 23, 2008.

(30) Foreign Application Priority Data
Jun. 23, 2008 (GB) 0811463.9

(51) Int. Cl. H04N 7/025; H04N 5/445

(52) U.S. Cl. 725/34; 725/39; 725/46

(57) ABSTRACT

Method and system for enabling different information-containing units such as advertisements, to be included in or otherwise presented in conjunction with broadcast content so that individuals receiving the same content can be presented with different information. A suitable information unit for each individual is independently selected based on information about each user. For example, when the broadcast content is on multiple channels and the user's terminal is receiving content on one channel having information that is not suitable for that user, the individual's terminal may be directed to switch to another channel selected from among a plurality of different channels based on the user's settings, profile and/or rules. As such, the information, or data units, being provided to each user can be customized thereby providing an extremely effective form of direct and targeted advertising in the broadcast of various content, such as television programs, radio programs, data, videos and audio.

### FIELD OF THE INVENTION

The present invention relates generally to methods and systems for presenting data to a user of a terminal in conjunction with broadcast content being received by the terminals and more particularly to methods and systems for selecting one or more data-containing units to present to the user of the terminal so that the user may be presented with an accurately targeted information.

### BACKGROUND INFORMATION

The introduction of mobile terminals, such as mobile telephones, with sufficient connectivity enabled by broadband 3rd generation (3G), wireless local area network (WLAN) and/or broadcast connectivity, such as Digital Video Broadcasting for Handheld (DVB-H) together with the installation of color screens on such terminals and the processing power provided to such terminals has facilitated the broadcast of television programs to the mobile terminals. This is generally known as mobile television or mobile TV.

When broadcasting television programs to homes, there are a few different models to manage the broadcast. The same models apply when broadcasting television programs to mobile terminals, although modifications may be implemented. One model is a pay TV model wherein a subscriber pays to watch television programs and/or subscribes to a television service for a specific time period. Another model is free television which is typically paid for by advertisers that pay to insert advertisements into time slots formed between portions of the television programs.

A typical broadcast-based advertisement model in the television (and radio) business relies primarily on predictions about the target audience of the television channel and more particularly, predictions about the target audience of a particular program that is being broadcast at any given moment on the television channel. There are companies, such as Nielsen Research, which utilize a business model to provide this type of prediction as well as a subsequent analysis service to check the accuracy of the prediction in order to improve subsequent predictions about the target audience's characteristics with respect to the viewing of the television channel and programs being broadcast thereon.

As is well known, the initial predictions of the target audience of information-containing units such as commercial advertisements inserted between portions of television programs are often inaccurate. Indeed, accurate predictions of the target audience of commercial advertisements inserted between portions of television programs are difficult to make because target audience members often change the television channels at some point during the broadcast of the program and therefore may not view the advertisements, or target audience members might not be watching the television when the advertisement is aired or the target audience might be watching a different program. It is therefore difficult to optimize the delivery of advertisements to television viewers.

As a result of this difficulty, there is a relatively low “cost per eye ball” or CPM (cost per millennium) for delivering advertisements on television. Nonetheless, popular television programs statistically collect large audiences and therefore provide beneficial advertisement opportunities for advertisers.

Another difficulty in optimizing the delivery of advertisements to television viewers is that all of the viewers usually do not belong to the target audience, i.e., there is typically a diverse audience watching each television program. Thus, a marketing message or advertisement addressed to one target audience will not be effective to viewers of a different target audience watching the same television program. In view of these difficulties, it is known to broadcast specific types of advertisements based on the likely or predicted profile of the majority of the viewers of each television show, or based on the location of the viewers. In the former situation, an advertiser would select one type of advertisement to include in a televised sporting event, such as a car race which would appeal to the likely, male majority of viewers, and another type of advertisement to include in a cartoon which would appeal to the likely majority of child viewers. In the latter situation, an advertiser would select one advertisement to include in a televised broadcast of a program to viewers in one geographic area, e.g., in London, and another advertisement to include in the televised broadcast of the same program but to viewers in a different geographic area, e.g., to the Manchester area. These techniques are not entirely effective in that inherently there will still be some viewers of each television program who do not belong to the target audience for a television program.

It would therefore be desirable to implement direct or targeted advertising to television viewers viewing broadcast content, or others receiving different forms of broadcast content, wherein information is specifically directed to individual users, or at a minimum, a more profiled advertising campaign wherein advertisements are specifically directed to discrete groups of people. Such direct, targeted or profiled advertising would be desirable for any form of broadcast system, including digital TV, mobile TV, radio, cellular broadcasting, radio (FM/AM/DAB) broadcasting, web casting, Internet radio and Internet TV, IP broadcasting, Podcasting, and the like.

### SUMMARY OF THE INVENTION

The present invention is directed at least in part to a method and system for enabling different data-containing units to be included in a television broadcast stream so that individual viewers watching the same television program can be presented with different information, e.g. in the form of advertisements. One technique to achieve this is to enable the device receiving the television broadcast stream to switch, select and/or zap to an information channel, selected from among a plurality of different information channels based on the viewer's profile, interest and/or settings, when there is a time slot in the broadcast stream intended for an information such as advertisements. As a result, the information being provided to the viewer can be customized to the viewer thereby providing an extremely effective form of direct and targeted advertising in the broadcast of television programs. The same technique can be applied in the broadcast of other types of content including but not limited to radio programs, data, videos, audio, etc. Moreover, the same technique can be applied to present one or more advertisements to the viewer other than during breaks or time slots in a program, e.g., prior to the program, after the program, or as an interruption to the program.

Although generally the description herein relates to the presentation of advertisements in conjunction with the presentation of broadcast content to a user, it is understood that any data-containing unit may be presented in conjunction with the broadcast content (before, during or after), an advertisement being only one such example of a data-containing unit. Another example is a public service announcement which, rather than being commercial is nature, is informative in nature. The invention therefore contemplates a system, method and computer program which have access to a plurality of the data-containing units and select one to present to the user in conjunction with the desired broadcast content.

### BRIEF DESCRIPTION OF THE DRAWINGS

The invention, together with further objects and advantages thereof, may best be understood by reference to the following description taken in conjunction with the accompanying drawings, wherein like reference numerals identify like elements, and wherein:

FIG. 1 shows an arrangement of a system for broadcasting content to a terminal in which the present invention can be applied;

FIG. 2 shows an exemplifying arrangement of a network for broadcast content on a plurality of channels;

FIG. 3 shows a single broadcast channel including multiple programs, in this case, television programs;

FIG. 4 shows a broadcasting schedule of, for example, television programs in a broadcast television channel;

FIG. 5 shows an example of the content of an Electronic Service Guide in XML format;

FIG. 6 is a diagram showing the broadcast of three broadcast channels by a broadcast content management system in accordance with the invention;

FIG. 7 is a diagram showing the manner in which a terminal receiving broadcast content switches between channels in accordance with the invention;

FIG. 8 is a flow chart showing the manner in which a terminal is arranged to obtain advertisements to present to a user of the terminal based on parameters of the user;

FIG. 9 is a schematic of a first embodiment of an advertisement management system in accordance with the invention;

FIG. 10 is a schematic of a second embodiment of an advertisement management system in accordance with the invention; and

FIG. 11 is a schematic of components of a terminal that can apply the technique in accordance with the invention.

### DETAILED DESCRIPTION

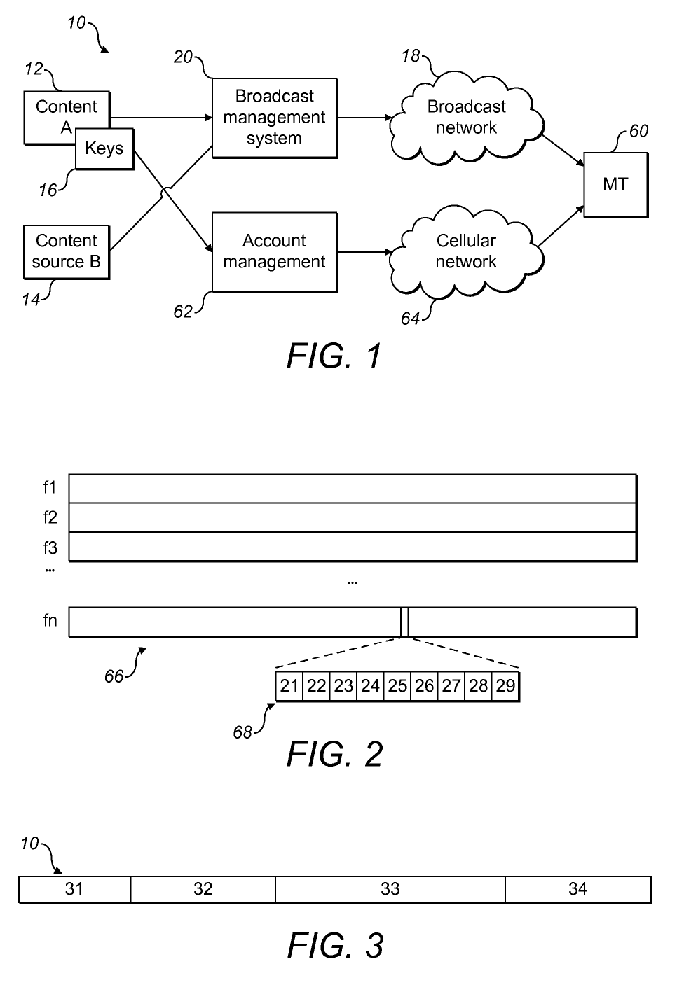

Referring to the accompanying drawings wherein the same reference numerals refer to the same or similar elements, FIG. 1 shows an arrangement of a system 10 for broadcasting content to a terminal in which the present invention can be applied. In this exemplifying, non-limiting arrangement, there are two different content sources 12 and 14 whereby content from content source 12 is protected by set of digital rights management (DRM) keys 16. It should be understood that a system in accordance with the invention may include any number of different content sources, each of which may provide content which is optionally protected by a set of DRM keys.

Content from one or more of the content sources 12, 14 is fed to a broadcast network 18 via a broadcast management system 20, to ultimately be delivered to a user's terminal 60. Terminal 60 may be a mobile terminal, mobile phone, smart phone, stationary terminal, personal computer (PC), laptop computer, television set, set-top-box, radio, radio receiver, iPod, MP3 player, mobile phone, accessory etc., basically any terminal or device capable of receiving broadcast content. Broadcast content may include audio, video, data, etc., and combinations thereof, e.g., television programs. Further, if the content includes a video component, then the terminal 60 would include a display, e.g., an external viewable display. If the content includes an audio component, then the terminal 60 would include a speaker or other hardware to enable sound reproduction. Terminal 60 will also invariably include a processor, one or more receivers to receive the broadcast content and one or more memory components. The processor, receivers and memory components may have any construction known to those skilled in the art.

In view of the use of DRM keys 16 to protect the content from content source 12, i.e., content from content source 12 is paid content, an account management system 62 is required. The account management system 62 can be used to deliver DRM keys 16 generated by or at the direction of content source 12 to the terminal 60 via a communications network, e.g., cellular network 64, and/or can be arranged to generate DRM keys 16 itself and deliver them to the terminal 60 via the cellular network 64. The cellular network 64 may also be used as a channel from the terminal 60 to the account management system 62 to enable the user to pay for a subscription which may be required in order to obtain the paid content from content source 12, i.e., the DRM keys 16. On the other hand, the content from content source 14 is free, i.e., does not require payment, and therefore, there is no need for an account management system interposed between the content source 14 and the user's terminal 60. However, an account management system, when present, could still be used to deliver “free” keys to enable access to the content from content source 14, if needed (in this case, DRM keys 16 would also be associated with content source 14).

Broadcast management system 20 typically generates an Electronic Service Guide (ESG) for the services which are being broadcast, i.e., the programs on the channels which constitute the content being provided by the content sources 12, 14. The broadcast management system 20 may also perform transcoding, when necessary, and typically can do Internet Protocol addressing, also when necessary, to forward one or more of the programs to the appropriate broadcast destination.

The Electronic Service Guide (ESG) (alternatively referred to as an Electronic Program Guide) is an important feature of mobile television systems. Basically, the ESG is a standardized method of providing information to receivers on terminals 60 on the currently broadcast and forthcoming television programs and other data or audio broadcasts. Typically, the ESG is delivered as part of the (DVB-H) broadcast transmission. The ESG enables a user to view a channel guide and select a program to view via a user interface of their terminal 60. Additional information about the ESG can be found, for example, in Nokia DVB-H Mobile TV Implementation Guidelines, Release 3.0 “OMA BCAST ESG Datamodel for IP Datacast over DVB-H” and, for example, in IP Datacast over DVB-H: Electronic Service Guide (ESG)—TS 102 471 v1.2.1 (ESG). Other broadcast systems, e.g., a radio broadcast system, would include a schedule of the broadcast content which is similar to the ESG.

The broadcast network 18 can therefore be, for example, a DVB-H network. A typical configuration of such a broadcast network 18 comprises a plurality of transmission and processing elements such as Multiprotocol Encapsulations (MPE) and DVB-H transmitters (tx). There are often anywhere from ten to fifty television programs or streams which can be broadcast at the same time in each frequency allocated for the DVB-H, and in any number of different channels.

DVB-H implementation is only one example of the form of broadcast network 18. Alternative mobile TV formats standards include, but are not limited to, DVB-T, DVB-S, DVB-C, DMB, ISDB-T, DAB, MediaFlo, MBMS (Multicast Broadcast Multimedia Service) over WCDMA, GSM, WLAN broadcast etc., and in some of these formats, the transport stream structure may differ from DVB-H format.

When using a radio (audio) broadcast, the broadcast may utilize any one of FM, AM, DAB, etc., radio technologies. When using FM radio, RDS signals may be used to signal proper breaks or time slots. When using DAB radio, a “DAB service guide” may be used. In addition, the TV/audio might be provided using cellular connectivity.

Terminal 60 comprises at least one receiver for broadcast TV, for example, a DVB-H receiver, and related software and hardware for showing the broadcast program in a screen or display of the terminal 60. The terminal 60 can be a monolithic terminal wherein all components are integrated in single terminal or alternatively, the terminal 60 can include separate parts which can be connected together using wires or wirelessly (such as providing a separate DVB-H receiver and display part). Terminal 60 can also include also a cellular connectivity part such as a Global System for Mobile communications (GSM) transceiver or 3^{rd} generation (3G) transceiver or wireless local area network (WLAN) transceiver and related hardware and software. In this case, the broadcast network 18 would be a corresponding GSM, 3G, WLAN, etc. network.

FIG. 2 shows an arrangement of a network which is used to broadcast mobile television channels (using a DVB-H communications network). In the network, there are one or more frequencies allocated for the broadcast (f1, f2, . . . , fn). In Europe, a typical channel width for the frequencies is about 8 MHz and in the U.S., a typical channel width for the frequencies is about 6 MHz.

A mobile television broadcast might be arranged to use time slice technology wherein programs in a single transmission 66 are partitioned or segmented into a plurality of time slices 68 (designated 21, 22, . . . , 29, . . . ). The programs may be allocated periodically to certain time slices. For example, a first TV channel (or program) designated “1” may be allocated time slices 21, 23, 25, etc. and a second TV channel (or program) designated “3” may be allocated time slices 22, 24, 26, etc. Typically, the terminal 60 is configured to have a receiver on only during those time slices allocated to a desired channel (or program) in order to save power in the terminal 60. In this regard, reference is made to U.S. Pat. No. 6,907,028, incorporated by reference herein, which describes techniques to allow a mobile terminal to periodically remove power from the receiver, or a receiving module, during times when the mobile terminal is not scheduled to receive desired content.

Terminal 60 may include appropriate computer hardware and software to buffer television program bursts, caching or storing portions of the television programs in memory, and then showing the stored television program portions as a continuous stream on a display of the terminal 60, i.e., to be viewed by the user. The terminal 60 could also be arranged to save the television program for later use.

Data structure in DVB-H format broadcasts contains a transport stream (TS), wherein the actual television programs might be encapsulated in Internet protocol (IP) packets that are carried in the TS. Programs might be coded to various audio and video codecs such as MPEG4, MPEG2, 3GPP, etc.

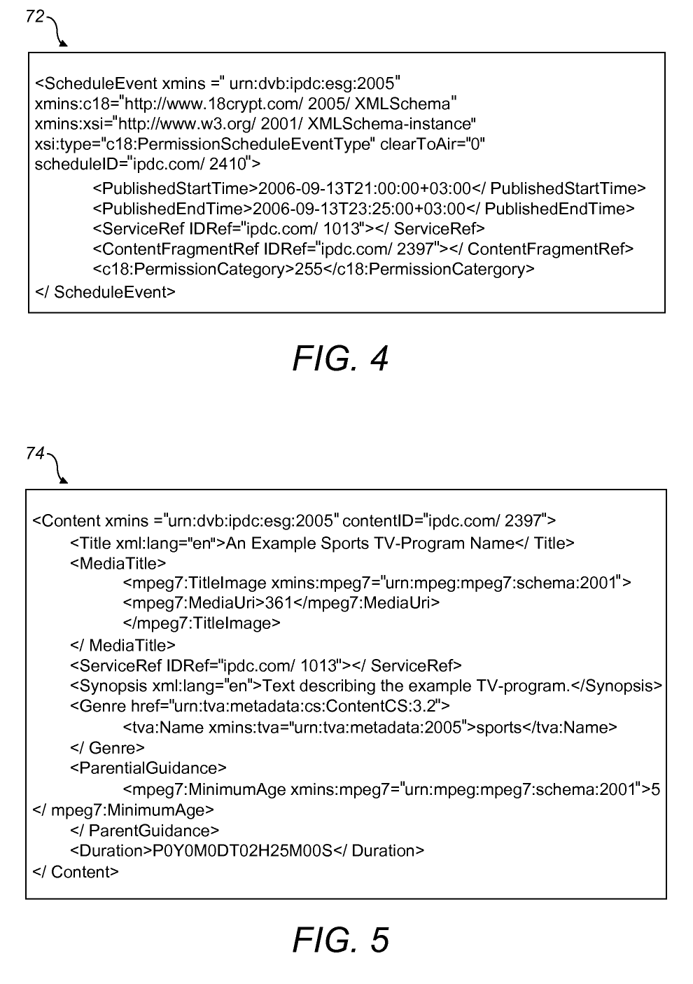

FIG. 3 shows a television broadcast channel 70 including multiple television programs, designated 31, 32, 33, 34. The programs 31, 32, 33, and 34 are broadcast according to a set broadcast schedule 72 shown in FIG. 4. The schedule 72 is an example of a part of the ESG (namely <ScheduleEvent>), and shows the starting time and ending time, <PublishedStartTime> and <PublishedEndtime>, for a program. The schedule 72 is typically an XML file.

Another example of an element of the ESG is designated 74 and shown in XML format in FIG. 5. The <Content> includes, for example, the name of a television program <Title>, as well as for example, a representative image of the program “TitleImage”, the genre of the program “Genre”, the duration of the program, and other information about the program.

A broadcast television management system in accordance with the invention includes equipment to broadcast multiple channels of television programs to mobile terminals equipped with receivers. Some channels may include only television programs without information such as advertisements and include time slots into which advertisements broadcast on another channel may be inserted. Other channels may broadcast television programs with pre-assigned information units such as advertisements in pre-designated time slots. Still other channels may broadcast only advertisements. The channels including broadcast advertisements may be synchronized such that some or all of the advertisements are broadcast at the same time or close to the same time.

Different entities may broadcast different components to the terminal 60. For example, one entity may broadcast one or more of the television programs on one or more channels while one or more other entities broadcast advertisements on dedicated channels. Still another entity might broadcast a programming schedule, e.g., an ESG, which provides information on the content being broadcast as well as on the advertisements being broadcast. Any of these entities can provide a computer program or software component to the terminal 60 to enable it to select which of a plurality of possible advertisements are most suitable for the user of the terminal.

For those channels which include broadcast information units, and which also use time slice technology, the units may be announced by allocating discrete periods of time or time slices to the units and including a transmission of the start time, end time, title, “TitleImage”, “Genre”, and other information or parameters about the units. This information may be included in the ESG or other schedule of the broadcast content.

In accordance with the invention, as the ESG is broadcast to terminals 60, the terminals 60 are arranged to consider the information provided in the ESG or otherwise available to a processor in the terminal 60, and determine whether a forthcoming advertisement in a program on a channel currently being viewed is suitable for the user of the terminal 60. That is, the terminal 60 includes means to determine whether the user is part of the target audience for the forthcoming advertisement. If not, the terminal 60 includes a mechanism to enable it to switch to another broadcast channel, e.g., a targeted advertisement channel, to enable the user to view a more suitable advertisement. The switching mechanism may be implemented as hardware and/or software. For example, the terminal side implementation may be in any OSI layer and the selection of advertisements may be performed in frequency level, based on time slice, TS level, IP level or in application level. Additional details about the manner in which the terminal 60 functions are described below with reference to FIG. 11.

The determination of whether the user is part of the target audience for the forthcoming advertisement may be based on the information about programs being broadcast or about to be broadcast contained in the ESG. This information may be analyzed in order to select advertisements from one of a plurality of different broadcast sources, i.e., another channel having advertisements. In this case, the information about the program may be the type of program and genre, as described above. Accordingly, it is necessary to monitor the ESG, i.e., data structures of the ESG, to obtain information about the programs and advertisements. It should therefore be understood by those skilled in the art that an actual implementation of ESG monitoring in accordance with the invention would likely differ depending on the technology and/or format of the mobile TV broadcast network.

Switching from one channel to another channel may be performed based on parameters in the terminal 60, e.g., parameters relating to the user which are stored for example in a memory component or database in the terminal 60. The stored parameters constitute stored information relating to or about the user of the terminal 60. The parameters in the memory component in the terminal 60 may be provided to the terminal 60 from a server system via a telecommunication system or communications network, e.g., cellular network described above with reference to FIG. 1. The server system may be associated with the broadcast television management system. Alternatively or additionally, the parameters may be set by the user of the terminal 60 using a user interface associated with the terminal 60, and thus would be stored in the terminal 60. The parameters can also be set and/or modified by software or a third party managing the broadcast television management system. The parameters relating to the user include settings provided by the user, profile information about the user provided by the user and/or an operator of the advertisement management system and/or rules provided by the user and/or operator. Profile information includes, for example, the user's gender, demographics about the user, the user's preferences, etc. Parameters might also relate to the user's presence and location, the proximity of the user to other terminals, and other settings/capabilities of the terminal 60.

The switching mechanism in the terminal 60 switches the receiver of the terminal 60 which is receiving the broadcast content at the beginning of the time period allocated to an information unit so there is a substantially seamless transition between the television program (or a preceding information unit) on a first channel and an information unit on a second channel. At the end of the time period allocated to the information unit, the switching mechanism switches the receiver back to the first channel having the television program or to another advertisement channel.

In an alternative embodiment, the switching mechanism in the terminal 60 is configured to switch the receiver to an advertisement channel before the advertisement slot in the television program currently being viewed, and cache or store an advertisement being broadcast on this advertisement channel for later showing to the viewer, i.e., at a predetermined time slot for an advertisement in the program. One or more information units may be stored in a memory component of the terminal 60 or possibly in the receiver of the terminal 60. The terminal 60 may be able to switch if the television program has been stored in its memory and is being played back from its memory. During the playback time, the terminal 60 is therefore able to switch to the channel to receive the information unit without affecting the viewing of the program by the viewer. This technique may be used in the other embodiments disclosed herein whenever an information unit is sought to be presented to a viewer so that it could either be provided in real-time to the viewer or alternatively, stored at an earlier time and then later presented during a break or time slot.

In yet another embodiment, information units are delivered to the terminal 60 via a different communications network than the one being used to receive broadcast television programs or other content and cached to the terminal 60. This second communications network may be implemented using IP connectivity over GPRS or WLAN. The ESG information would be used to indicate the IP address (URL) to be used to fetch or retrieve an advertisement.

Moreover, in some embodiments, the information units may be delivered to the terminal 60 via a secondary channel, such as mobile network or WLAN. For example, when the terminal 60 receives broadcast radio, the switching mechanism may be arranged to use another radio channel than the broadcast radio channels.

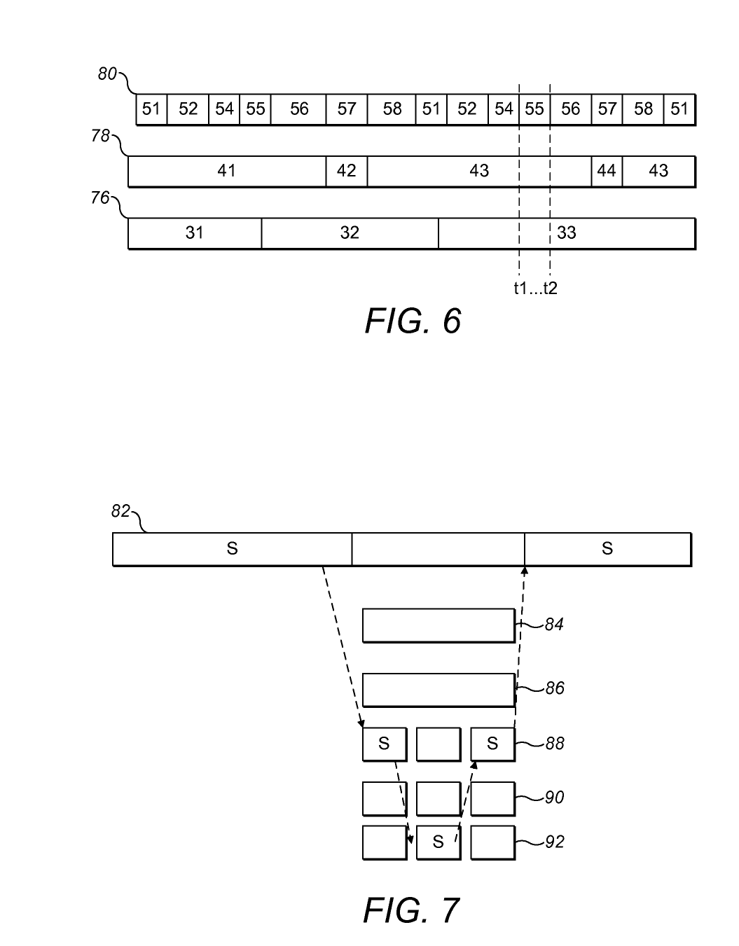

As an example of the foregoing operation of the switching mechanism implemented in the terminal 60, FIG. 6 shows television channels 76, 78, 80, wherein channel 76 includes television programs designated 31, 32 and 33, channel 78 includes television programs 41, 43 and advertisements 42 and 44 and channel 80 includes advertisements 51-58, i.e., an advertisement channel. Television program 33 has an allocated advertisement slot between time t1 and t2. At this time, advertisement channel 80 has an advertisement 55 being broadcast so that the switching mechanism in terminal 60 can switch the receiver of the terminal 60 from channel 76 to channel 80 at time t1 if the stored parameters in the terminal 60 indicate that advertisement 55 is suitable for the user of the terminal 60. If not, the switching mechanism could switch to another advertisement channel at time t1, since multiple advertisements channels are usually provided by the broadcast television advertisement management system. If the receiver of the terminal were switched at time t1 to channel 80, then at time t2, the end of the advertisement, the switching mechanism would switch the receiver of the terminal 60 from channel 80 back to channel 76 and thereby enable the viewer to continue watching program 33.

The determination of whether the advertisement on channel 55 at time t1 is suitable for the user of terminal 60 may be based on the parameters relating to the user of the terminal 60, as described above.

In another example, channel 78 has a pre-assigned advertisement break or time slot with an advertisement 42. At that time, the user might be shown the advertisement 42 (if it is deemed suitable for the viewer of the television program 41), advertisement 57 from advertisement channel 80 if it is deemed more suitable to the viewer than advertisement 42 (in which case, the switching mechanism of the terminal 60 would switch to channel 80 at the beginning of advertisement 57 and back to channel 78 at the end of advertisement 57) or possibly an advertisement embedded in program 32 being broadcast on channel 76, if available. In the latter case, the switching mechanism of the terminal 60 would switch to channel 76 at the beginning of the embedded advertisement and back to channel 78 at the end of the advertisement.

The broadcast television management system may cooperate with television broadcast equipment to transmit channels 76, 78, 80 at a single frequency or at different frequencies. In the latter case, they may be transmitted in the transport stream (TS) or in different transport streams.

One embodiment of the invention forms broadcast channels including one or more time slices or time slots allocated to advertisements and programs the terminal 60 to receive those time slices when needed. Thus, whenever the terminal 60 determines that an advertisement break or time slot is provided in a television program currently being viewed, it would switch to one of the channels with an allocated advertisement time slot and retrieve an advertisement to be presented to the viewer. The switching may be done only if a suitable advertisement is not otherwise available in the memory of the terminal 60 to display to the viewer, or without regard to the presence of an advertisement in the memory of the terminal 60.

FIG. 7 shows one possible manner in which the terminal 60 switches between a broadcast content channel 82 showing a television program, e.g., a football game, and advertisement channels 84, 86, 88, 90, 92 showing advertisements. The terminal 60 is arranged to display on the display thereof the material designated S, switching when necessary between channels 82, 84, 86, 88, 90, 92. As such, proceeding from left to right in FIG. 7 (representing the temporal dimension and following the arrows), the content presented on the display is first the football game on broadcast content channel 82, then the terminal 60 switches to advertisement channel 88 causing display of the advertisement being broadcast at that time on channel 88. When this advertisement is finished, the terminal 60 switches to advertisement channel 92 causing display of the advertisement being broadcast at that time on channel 92. When this advertisement is finished, the terminal 60 switches back to advertisement channel 88 causing display of the advertisement being broadcast at that time on channel 88. When this advertisement is finished, the terminal 60 switches to broadcast content channel 82 causing display of the football game.

Terminal 60 would initiate switching of its reception whenever a time slot 94 for placement of advertisements is detected. Preferably, the broadcast of advertisements on channels 84, 86, 88, 90, 92 is coordinated with the presence of a time slot 94 in a program on the broadcast content channel 82. However, in view of the lack of exact breaks in some programs, e.g., football games, it is conceivable that it might not always be possible to coordinate the broadcast of advertisements with the presence of time slots 94 and therefore advertisements may be continually broadcast on advertisement channels 84, 86, 88, 90, 92 to ensure the availability of an advertisement whenever there is a break in the program.

A computer program in the terminal 60 enables the switching functionality and controls the switching based on selection of advertisements on the advertisement channels 84, 86, 88, 90, 92 as described below. The determination of which advertisements to broadcast on each of channels 84, 86, 88, 90, 92 and/or when to broadcast them may be done locally, i.e., independent of one another, without coordination between the entities managing the broadcast of the advertisements on channels 84, 86, 88, 90, 92.

To provide information about the advertisements to enable a selection of an advertisement to be presented to a user of the terminal 60 based on their stored settings, profile and/or rules, the ESG may be modified to include additional information about the advertisement, such as an extra description designated <AdvertisementType>. This description could be used to transmit information about the content of the advertisement and/or information about a target profile of a viewer of the advertisement. Thus, the description <AdvertisementType> may include information such as <gender> male/female, <target age>, <food>, <target location of consumer> etc. By transmitting such information to the terminal 60, a processor in the terminal 60 can make a determination whether the user is part of the target audience for the advertisement by considering the parameters relating to the user in the terminal 60 relative to the received information about the advertisement. These parameters may be stored in a database or other memory component in the terminal 60 and accessed by the processor when needed. This consideration may be an analysis of whether the stored parameters of the user result in the user belonging to the target audience, or a determination of a degree of similarity between a target profile of the viewer of the advertisement and the parameters relating to the user of the terminal 60. The processor would also control the switching mechanism to switch to a channel on which the advertisement is being broadcast if it determines that the user of the terminal 60 is part of the target audience for the advertisement being broadcast. As such, the processor in the terminal 60 determines the advertisements to display to the user, and then takes steps to present them to the user.

It is also possible to use the <Genre> field or parameter in the existing DVB-H standard, or similar parameter in other broadcast formats, to announce the profiles or target audiences of advertisements being broadcast. A terminal 60 configured in accordance with the invention to enable targeted advertising would therefore have its switching mechanism controlled by the processor to follow the defined “Genre”, or at least analyze the defined “Genre” data field relative to the information about the user available to the terminal 60. For example, the processor would include a stored “Genre”, which may be preset by the user or otherwise provided to the terminal, such as <Male, 16-24 years, lives in London>, and whenever the “Genre” data field or parameter in a broadcast advertisement is the same (and in a situation where the processor was looking for an advertisement to include in an advertisement break in a broadcast television program), the processor would consider that advertisement to be suitable for the user of the terminal 60 and cause the display that advertisement (switching channels to enable reception of that advertisement if needed). Thus, for example, after selecting the advertisement, the processor would use the information about the advertisement, i.e., when it is being broadcast, to obtain the advertisement by switching the receiver of the terminal at the appropriate time.

It is also possible to use a <ScheduleEvent> parameter with an embedded <AdEvent> description to show the start time and end time of an advertisement break. This will enable the processor in the terminal 60 to ascertain in advance when an advertisement is needed and allow the processor to determine which of the other broadcast channels have an advertisement available at the start time.

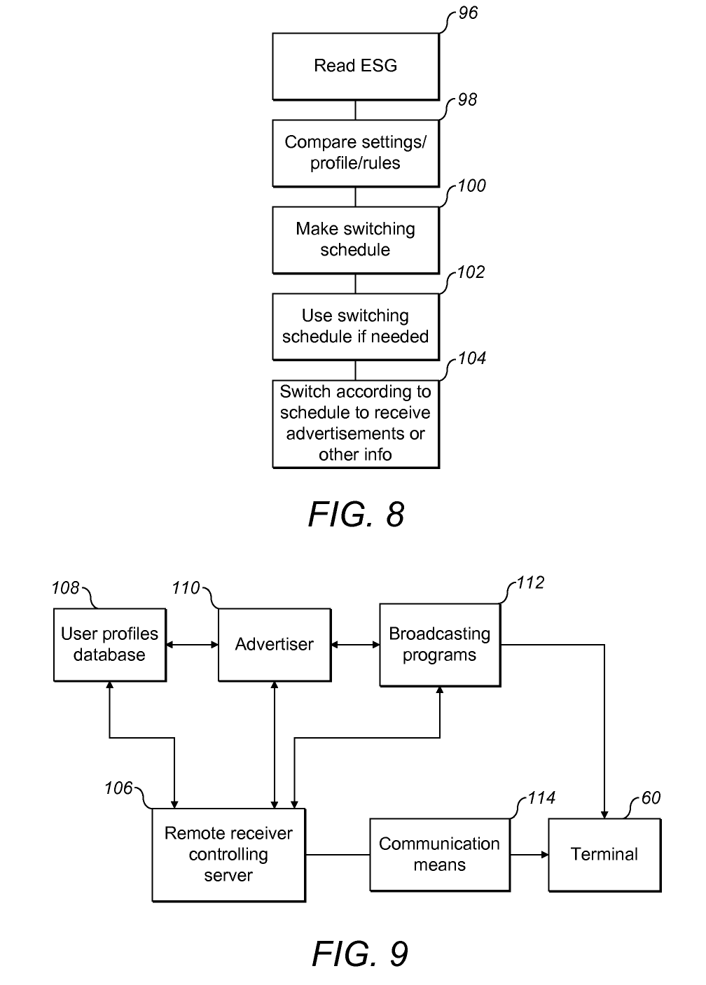

FIG. 8 is a flow chart of the manner in which a terminal 60 is arranged to obtain advertisements based on parameters of the user of the terminal 60 and thereby provide a targeted advertising system in accordance with the invention.

The first step 96 is for the terminal 60 to read the ESG and then compare the user's settings, profile and/or rules with the information about the advertisements in the ESG, step 98. The processor in the terminal 60 then makes a switching schedule in step 100, to obtain advertisements suitable for the user based on their settings, profiles and/or rules. The processor may be arranged to make a schedule for each of the television programs being broadcast, if the user has not yet selected a program to view, or only a single schedule for the program currently being viewed by the user. (As described below, these steps may alternatively be performed by equipment which is at a location separate and apart from the terminal 60—see FIG. 9 and the description thereof.) Then, in step 102, as the user views a television program, when there is an advertisement break or time slot, the processor directs the switching mechanism to switch to another broadcast channel in accordance with the switching schedule, and in step 104, obtains a suitable advertisement to insert into the advertisement break or time slot (see the discussion above with respect to FIG. 6).

Additionally or alternatively, the switching mechanism in the terminal 60 may be controlled by a transmission of a message, a signal and/or a data stream provided to the terminal 60 via a communications channel, such as GPRS, EDGE, GSM, WCDMA, WLAN, DVB-H, and the like. The message, signal or data stream would contain commands for controlling the broadcast television receiver to receive specific channels, switching to the different channels if necessary. Thus, the terminal 60 would be arranged to receive this message, signal or data stream and control the broadcast television receiver to switch to, for example, a targeted advertisement on another broadcast channel at one or more specific times. In this arrangement, there is no need for user setting, user profiles or rules in the terminal 60 because the receiver is controlled from a server system or via another terminal generating and providing the message, signal or data stream in consideration of the user settings, user profiles and rules. The server system or other terminal would therefore include or have access to a database containing the user settings, user profiles and rules and make a determination as to the switching schedule for each user. The user could be provided with means to access this remote database and make changes to their settings, profile and rules. The switching schedule would be used to generate an appropriate message, signal or data stream to be sent to each user's terminal to implement channel switching.

This embodiment is shown schematically in FIG. 9 wherein a remote receiver controlling server 106 communicates with a database 108 containing the user's settings, profiles and rules, with an advertisement management system 110 which provides advertisements to be broadcast and with broadcast equipment 112 which broadcast programs and advertisements on a plurality of channels. Database 108 may be representative of a single database or a plurality of database, each of which may be physically separated from the remote receiver controlling server 106 or co-located or integral therewith. The broadcast equipment 112 may be directly connected to the advertisement management system 110 and the advertisement management system 110 may also be directed connected to the database 108. The terminal 60 receives the broadcast channel from the broadcast equipment 112 and the message, signal or data stream from the remote receiver controlling server 106 through a communications network 114 which controls the switching implemented via the receiver. The remote receiver controlling server 106 receives the user settings, user profiles and rules from the database 108, advertisements from the advertisement management system 110, and data about when the advertisements will be broadcast (possibly the entire ESG from the broadcast equipment 112). After determining suitable advertisements for the user of each terminal 60, the remote receiver controlling server 106 generates messages, signals or data streams and causes their transmission to the terminal 60 via the communications network 114. The message, signal or data stream causes the receiver to switch channels to receive the suitable advertisements. These channel switching (or advertisement finding) rules can be stored in the terminal 60 for later usage or used in real-time or near real-time. These rules might be valid for one switching only, or for one or more channel switching or permanently, or for certain time period.

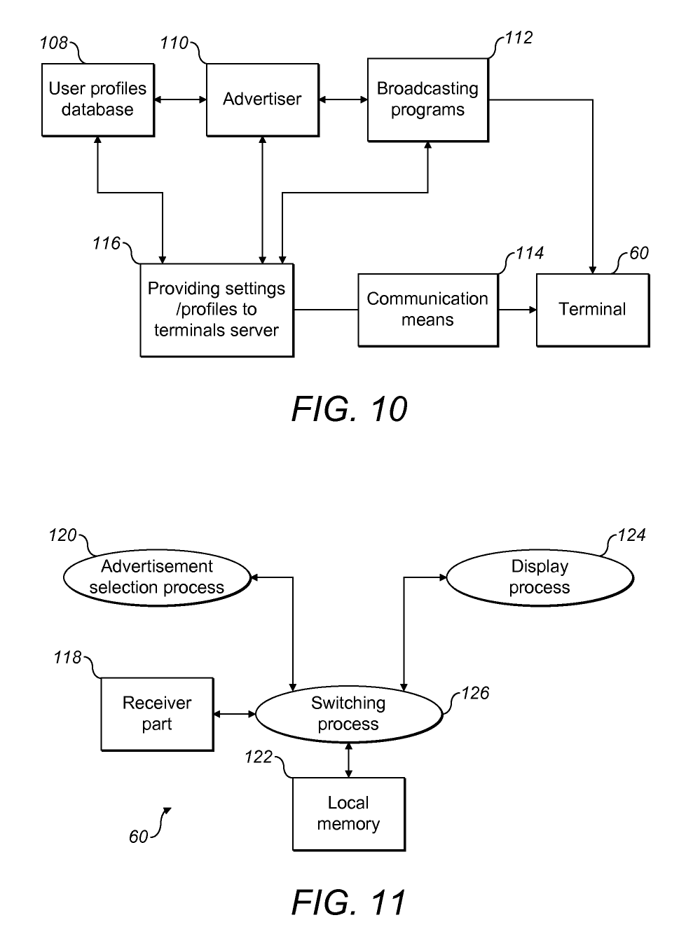

In an alternative embodiment of a broadcast television advertisement management system shown in FIG. 10, instead of the remote receiver controlling server 106, there is a control unit 116 which has the same connections to the database 108, advertisement management system 110, broadcast equipment 112 and communications network 114 as the remote receiver controlling server 106. Control unit 116 does not generate and direct a message, signal or data stream to the terminal 60 indicative of how the switch the receiver to cause reception of predetermined advertisements. Rather, control unit 116 provides the user settings, user profiles and rules from the database 106 to the terminal 60 in the form of a message, signal or data stream via the communications network 114. Then, the processor at the terminal 60 determines the switching schedule based on the user settings, profile and rules and the ESG and generates commands for the receiver to switch channels to receive suitable advertisements for the user of the terminal 60.

Broadcast equipment 112, in either embodiment shown in FIG. 9 or FIG. 10, can be used in a method and system for broadcasting content to terminals 60 in accordance with the invention. Content from one or more content sources (see FIG. 1) and advertisements from the advertisement management system 110 are broadcast in a plurality of channels. Information about the programs and/or advertisements in the channels is also broadcast, e.g., in an ESG or similar guide to the broadcast content, and which may possibly be broadcast in a different channel or using a different communications network. This information would include the start time and end time of the advertisement time slots. The channels may be synchronized such that each channel includes an advertisement at substantially the same time (see FIG. 6 wherein channels 78 and 80 have synchronized advertisements 42, 57 and 44, 57). As such, when a user of a terminal is viewing the content of a first channel, the terminal is able to switch to a second channel to provide an advertisement to the user from the second channel based on analysis of the broadcast information about the advertisements relative to information about the user of the terminal 60. The information about the user of the terminal 60 may be stored at a remote database accessed by an advertisement selection mechanism (database 108 which is accessed by the remote receiver controlling server 106—FIG. 9) or stored in the terminal 60 (after having been provided from the database 108 via the control unit 116—FIG. 10).

Referring to FIG. 11, to implement the invention, a typical configuration of terminal 60 would include a receiver mechanism 118 for receiving broadcast content including at least one time slot for an advertisement and for receiving a plurality of advertisements, which receiver mechanism 118 may be the same (when the content and advertisements are provided in the same manner or conjunction with one another) or different (when the content is provided in one communications protocol and the advertisements in another). A selection mechanism 120 selects one or more advertisements to include in each time slot of the received broadcast content based on information about the user of the terminal 60. This selection may be based on analysis of information about the user relative to the information about the advertisements, e.g., a degree of similarity between a target profile of a viewer of the advertisement and the information about the user. The information about the user of the terminal may be stored in a database, possibly a local memory 122 residing on the terminal itself. Alternatively, the information may be stored at a remote location separate and apart from the terminal 60 and the receiver mechanism 118 arranged to receive the information about the user of the terminal from that remote location.

The terminal 60 also includes a display or presentation mechanism 124 for displaying or otherwise presenting the content and the selected advertisement(s) to the user during each time slot, e.g., a display for television content and a sound reproduction unit for radio content.

To facilitate obtaining advertisements when the content and advertisements are broadcast on multiple channels, a switching mechanism 126 is provided in the terminal to switch reception of the receiver mechanism 118 of the terminal, for example, at a beginning of a time slot, from a first channel to a second channel when the selected advertisement is being broadcast on the second channel, and then either switching to a third channel or switching back to the first channel, e.g., at an end of the time slot (see FIGS. 6 and 7 and the description thereof).

In one embodiment, the selection mechanism 120 maintains and/or determines the rules for switching between different broadcast channels. For example, in case of the football game described above with reference to FIG. 7, the rules could be to cause a set of advertisements to be presented to the user based on the user's profile every ten minutes. Each time, the advertisements are to be presented, the selection mechanism 120 would initiate the switching mechanism 126 to obtain an advertisement from advertisement channel 88 (see FIG. 7). The switching mechanism 126 would be provided with information about the time slice containing the advertisement on channel 88 and generate and direct commands to the receiver mechanism 118 to cause the receiver mechanism 118 to obtain the advertisement based on the information about the time slice. If, for example, channel 88 is a physically different frequency than the frequency of the TV program being broadcast on channel 82, then the receiver mechanism 118 would be directed to switch to the appropriate frequency to receive the advertisement. In an embodiment wherein the receiver mechanism 118 is a DVB-H receiver and configured to receive certain TV programs or channels, the DVB-H receiver could be controlled by the switching mechanism 126, e.g., to receive content in certain frequencies, from certain IP address, from certain time slices etc.

Terminal 60 may also be constructed to function in additional or alternative ways. For example, in one embodiment, one or more advertisements are stored in local memory 122. In this case, the switching mechanism 126 would retrieve an advertisement from the local memory 122 instead of generating and directing commands to the receiver mechanism 118 to obtain the advertisement. Thus, the terminal 60 can present the selected advertisements in real-time or delayed if they are stored in a memory component of the terminal 60, e.g., the local memory 122.

Terminal 60 may also be configured to allow the advertisement selection mechanism 120 to run independent of the program being presented on presentation mechanism 124 and “over ride” the user-selected broadcast channel with advertisements. The frequency of “over riding” could be function of value of the user for the advertiser and/or cost of the program. For example this “over riding” feature could allow implementation of free pay TV by providing DRM keys to the terminal 60 in exchange for the allowing program “over ride”, i.e., interruption of the program to present advertisements.

A variable model for pay TV is therefore provided whereby a user can determine how many advertisements they are willing to view in order to receive content for which payment is required and the cost to view such content varies as a function of the number of advertisements they will receive during the presentation of the content on their terminal 60. If the user is willing to view a maximum number of advertisements, then the content may be provided for free. On the other hand, a user willing to receive only a predetermined minimum number of advertisements would pay more than a user willing to receive more advertisements but less than the maximum number of advertisements. The price levels to view the content relative to the number of advertisements to be received can be controlled by the content provider, the advertisers, the operator of the advertisement management system, or another entity involved in the advertising system disclosed herein. A user can therefore be presented with the options for receiving paid content and can select how many advertisements they want to receive (in which case, a corresponding cost would be predetermined) or how much they want to pay (in which case, the number of advertisements would be predetermined). Each user therefore has control over the manner in which they will receive paid broadcast content, such as pay TV programs.

A business model for providing pay TV or other types of pay broadcast content is therefore envisioned wherein users determine either the price they are willing to pay for content with knowledge of the number of advertisements to receive in order to be able to access the content, or the number of advertisements they are willing to receive with knowledge of the price they will be charged in order to be able to access the content.

As described above, the terminal 60 may be arranged to present advertisements to the user during designated time slices, time slots or time breaks in broadcast content programs. In this case, the presentation of the advertisements via presentation mechanism 124 would be synchronized with the presentation of the content program, e.g., TV program. On the other hand, it is also possible to present advertisements randomly, based on location of the terminal 60, based on timing such as at periodic, predetermined time intervals, and based on other criteria such as when the user starts to receive the channel, stops receiving the channel, after receiving a phone call to the terminal, during the phone call, etc. The criteria may thus relate to the user's actions relative to the broadcast content or the user's action relative to the terminal 60. The computer program in terminal 60 may be programmed as desired to enable this variability in the manner in which advertisements are presented to the user relative to the broadcast content.

An application of the invention will now be described. Assuming that a predicted audience of 100,000 users of terminals is watching the same television program, 50,000 are males and 50,000 are females, and that 25,000 of the females prefer information on food over information on magazines. There are three alternative advertisements for the advertisement slot: a generic advertisement for all viewers for which the price to an advertiser is $0.05/viewer; an advertisement for a car aimed at male viewers for which the price is $0.07/male viewer; and an advertisement for food aimed at female viewers for which the price is $0.10/female receiver. In a prior art system, an operator of a television channel determined the revenue to be gained from broadcasting each of the advertisements to all of the viewers and often broadcast whichever advertisement yielded the highest revenue. Using the above information about the viewers obtained from survey companies, such as Nielsen Research, they would determine that the first advertisement would yield $5,000.00 ($0.05×100,000), the second advertisement would yield $3,500.00 ($0.07×50,000) and the third advertisement would yield ($2,500.00 ($0.10×25,000). The operator would therefore select the first, generic advertisement, providing $5,000.00 in revenue.

In accordance with the invention however, all three advertisements could be broadcast simultaneously by synchronizing their broadcast on different channels and the user of each terminal 60 would receive one of the three advertisements depending on their settings, profile and rules (as described above). Thus, the 50,000 male viewers would view the second advertisement, the 25,000 female viewers who prefer information about food would receive the third advertisement and the remaining 25,000 female viewers would receive the first, generic advertisement. This would increase revenue to the operator since the revenue generated would be $7,250.00 (($0.07×50,000)+($0.10×25,000)+($0.05×25,000)).

In addition, the ability for users of the terminal 60 to individually tailor their settings, profile and rules provides significant improvement in obtaining information about the audience in comparison to traditional audience prediction techniques. Indeed, quite often, the demographics-based analysis of the viewing audience is only an estimate and differs significantly from the actual audience. Thus, even if only one person provides information about his or her profile, setting and rules to enable a directed or targeted advertisement to be sent to this person instead of a generic advertisement, the revenue to the operator would increase since a directed advertisement commands a higher price per viewer.

By requiring users of terminals 60 to provide profile information, this information greatly improves the ability to obtain data about the viewers of television programs since it is known which terminals are receiving which programs and data about the viewers is contained in the database 94. If the data about the viewers is contained on each of their terminals 60, the system may be designed to forward such information to the advertisement management system 96 and thereby centralize the collection of data about the viewers.

The foregoing enables innovative and focused mobile marketing and advertising. Indeed, the popularity of mobile telephones having television reception capabilities has enabled their use, along with related infrastructure, as a media for providing mobile marketing, i.e., advertisements to the users of the telephones.

This is important because such a concept is considered by advertisers as the next new channel to directly reach consumers since it utilizes core assets and characteristics of the mobile media, namely, it is personal in that it is directed solely to individual consumers, it is “always on” and can reach the consumers whenever they access their communications devices, it is mobile and naturally forms groups of people who communicate actively with each other. These characteristics combined with social networks-based approaches of the Internet could form a very powerful base to execute marketing strategies.

In general, mobile marketing and advertising can be divided into the following four categories: mobile marketing, mobile advertising, mobile direct marketing and mobile customer relation management (CRM). The present invention in any of its forms discussed above is applicable to all categories.

Mobile marketing is commonly considered as the systematic planning, implementing and control of a mix of business activities intended to bring together buyers and sellers for the mutually advantageous exchange or transfer of products or services where the primary point of contact with the consumer is via their mobile device.

Mobile advertising is commonly considered as the paid, public, non-personal announcement of a persuasive message by an identified sponsor as well as the non-personal presentation or promotion by a firm of its products to its existing customers and potential customers where such communication is delivered to a mobile telephone or other mobile device. Examples of mobile advertising include: Wireless Application Protocol (WAP) Banner ads, mobile search advertising, mobile video bumpers, and interstitial ads in or on device portals.

Mobile direct marketing is commonly considered a sales and promotion technique in which promotional materials are delivered individually to potential customers via the potential customer's mobile telephone or other mobile device. Examples of mobile direct marketing include the sending of Short Message Service (SMS), Multimedia Message Service (MMS) or Wireless Application Protocol (WAP) push messages, Bluetooth messaging and other marketing to mobile telephones or other mobile devices.

Mobile customer relation management is commonly considered as a combination of all the foregoing in a manner that establishes a long-term, engaging relationship between the customer and the marketing or promoting company.

Several computer programs resident on computer-readable media may be used in the invention. One computer program is resident in the terminal 60 and controls the presentation of the advertisements to the user while another is resident in the remote receiver controlling server 106 and determines the switching schedule. Another may be resident in the control unit 116 and controls the forwarding of information about the user of the terminal 60 and information about broadcast content and broadcast advertisements to the terminal 60.

In the context of this document, computer-readable medium could be any means that can contain, store, communicate, propagate or transmit a program for use by or in connection with the method, system, apparatus or device. The computer-readable medium can be, but is not limited to (not an exhaustive list), electronic, magnetic, optical, electromagnetic, infrared, or semi-conductor propagation medium. The medium can also be (not an exhaustive list) an electrical connection having one or more wires, a portable computer diskette, a random access memory (RAM), a read-only memory (ROM), an erasable, programmable, read-only memory (EPROM or Flash memory), an optical fiber, and a portable compact disk read-only memory (CDROM). The medium can also be paper or other suitable medium upon which a program is printed, as the program can be electronically captured, via for example, optical scanning of the paper or other medium, then compiled, interpreted, or otherwise processed in a suitable manner, if necessary, and then stored in a computer memory. Also, a computer program or data may be transferred to another computer-readable medium by any suitable process such as by scanning the computer-readable medium.

Having described exemplary embodiments of the invention with reference to the accompanying drawings, it will be appreciated that the present invention is not limited to those embodiments, and that various changes and modifications can be effected therein by one of ordinary skill in the art without departing from the scope or spirit of the invention as defined by the appended claims.

1. A method for receiving content at a user's terminal, comprising:
receiving broadcast content at the terminal;
receiving a programming schedule containing information about a plurality of different data-containing units to be broadcast; and
selecting one of the data-containing units to present to the user in conjunction with the received broadcast content based on the programming schedule and stored information relating to the user of the terminal.

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. A method for broadcasting data-containing units receivable by a terminal to enable specific data-containing units targeted to the user of the terminal to be presented in conjunction with content being broadcast in at least one channel, comprising:
broadcasting the data-containing units in at least one additional channel;
broadcasting a programming schedule containing information about a plurality of different data-containing units; and
enabling the terminal to switch between channels to obtain the content and data-containing units from different channels based on analysis of the information about the data-containing units relative to stored information relating to the user of the terminal.

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. (canceled)

45. (canceled)

46. (canceled)

47. (canceled)

48. A method for a terminal to control presentation of received broadcast content to a user thereof, comprising:
selecting one of a plurality of available data-containing units to present based on stored information relating to a user of the terminal; and
presenting the selected data-containing unit to the user in conjunction with the received broadcast content.

49. (canceled)

50. (canceled)

51. (canceled)

52. (canceled)

53. (canceled)

54. (canceled)

55. (canceled)

56. (canceled)

57. (canceled)

58. (canceled)

59. (canceled)

60. (canceled)

61. An apparatus for receiving content at a user's terminal, comprising:
receiver means arranged on the terminal for receiving broadcast content and for receiving a plurality of data-containing units; and
selection means coupled to said receiver means for selecting one of the data-containing units received by said receiver means to present in conjunction with the broadcast content received by said receiver means based on stored information relating to the user of the terminal.

62. (canceled)

63. (canceled)

64. (canceled)

65. (canceled)

66. (canceled)

67. (canceled)

68. (canceled)

69. (canceled)

70. (canceled)

71. (canceled)

72. (canceled)

73. (canceled)

74. (canceled)

75. (canceled)

76. (canceled)

77. (canceled)

78. (canceled)

79. (canceled)

80. (canceled)

81. (canceled)

82. (canceled)

83. (canceled)

84. (canceled)

85. (canceled)

86. A terminal capable of receiving broadcast content and controlling presentation of data-containing units in the broadcast content to a user thereof, comprising:
receiver means for receiving broadcast content and for receiving a plurality of data-containing units;
selection means coupled to said receiver means for selecting one of the data-containing units received by said receiver means to present based on stored information relating to the user of the terminal; and
presentation means for presenting the received broadcast content and the selected data-containing unit to the user.

87. (canceled)

88. (canceled)

89. (canceled)

90. (canceled)

91. (canceled)

92. (canceled)

93. (canceled)

94. (canceled)

95. (canceled)

96. (canceled)

97. (canceled)

98. (canceled)

99. (canceled)

100. A terminal capable of receiving broadcast content and controlling presentation of data-containing units in the broadcast content to a user thereof, comprising:
a receiver mechanism arranged to receive broadcast content and to receive a plurality of data-containing units;
a selection mechanism coupled to said receiver mechanism and arranged to select one of the data-containing units received by said receiver mechanism to present based on stored information relating to the user of the terminal; and
a presentation device coupled to said receiver mechanism and arranged to present the received broadcast content and the selected data-containing unit to the user.

101. (canceled)

102. (canceled)

103. (canceled)

104. (canceled)

105. (canceled)

106. (canceled)

107. (canceled)

108. (canceled)

109. (canceled)

110. (canceled)

111. (canceled)

112. (canceled)

113. (canceled)

114. A computer program resident on computer-readable media at a terminal and arranged to control presentation of data-containing units to a user of the terminal in conjunction with content being broadcast in at least one channel, the computer program being arranged to:
select one of a plurality of available data-containing units to present based on stored information relating to the user of the terminal; and
present the selected data-containing unit to the user in conjunction with the broadcast content.

115. (canceled)

116. (canceled)

117. (canceled)

118. (canceled)

119. (canceled)

120. (canceled)

121. (canceled)

122. (canceled)

123. (canceled)

124. (canceled)

125. A computer program resident on computer-readable media at a terminal and arranged to control presentation of data-containing units to a user of the terminal in conjunction with broadcast content, the computer program being arranged to:
read an electronic service guide containing information about content and data-containing units being broadcast on a plurality of channels;
compare information about the data-containing units to information relating to the user to determine suitable data-containing units for the user;
make a schedule for switching between channels in order to obtain the suitable data-containing units;
switch between the channels to obtain the suitable data-containing units; and
present the content and obtained data-containing units.

126. (canceled)

127. (canceled)

128. (canceled)

129. (canceled)

130. (canceled)

131. (canceled)

132. A computer program resident on computer-readable media at a server and arranged to control presentation of data-containing units to a user of a terminal in conjunction with broadcast content, the computer program being arranged to:
read an electronic service guide containing information about content and data-containing units being broadcast on a plurality of channels;
compare information about the data-containing units to information relating to the user to determine suitable data-containing units for the user; make a schedule for switching between channels in order to obtain the suitable data-containing units; and
provide the schedule to the terminal via a communications network to enable the terminal to switch between the channels to obtain the suitable data-containing units and then present the content and the obtained data-containing units.

133. (canceled)

134. (canceled)

135. (canceled)

136. (canceled)

137. (canceled)

138. A method for a terminal to control presentation of data-containing units to a user in conjunction with broadcast content, comprising:
reading an electronic service guide containing information about content and data-containing unit's being broadcast on a plurality of channels;
comparing information about the data-containing units to information relating to the user to determine suitable data-containing units for the user;
making a schedule for switching between channels in order to obtain the suitable data-containing units;
switching between the channels to obtain the suitable data-containing units; and
presenting the content and obtained data-containing units.

139. (canceled)

140. (canceled)

141. (canceled)

142. (canceled)

143. (canceled)

144. A method for controlling presentation of data-containing units to a user in conjunction with broadcast content, comprising:
reading an electronic service guide containing information about content and data-containing units being broadcast on a plurality of channels;
comparing information about the data-containing units to information relating to the user to determine suitable data-containing units for the user;
making a schedule for switching between channels in order to obtain the suitable data-containing units; and
providing the schedule to the terminal via a communications network to enable the terminal to switch between the channels to obtain the suitable data-containing units and then present the content and the obtained data-containing units.

145. (canceled)

146. (canceled)

147. (canceled)

148. An Electronic Program Guide (EPG) embodied in computer-readable medium for use in enabling a terminal to select one of a plurality of data-containing units to present to a user of the terminal, comprising:
information about the data-containing units; and
information about a target audience of the data-containing units,
whereby a terminal receiving the EPG can analyze the information about the target audience relative to stored information about the user and select one of the data-containing units to present to the user, and then obtain the selected data-containing units based on the information about the data-containing units to enable its presentation to the user.

149. (canceled)
